(19) United States
(12) Patent Application Publication
(10) Pub. No.: US 2004/0114481 A1
(43) Pub. Date: Jun. 17, 2004

(54) Optical information storage medium and method of and apparatus for recording and/or reproducing information on and/or from the optical information storage medium

(75) Inventors: Jae seong Shim, Seoul (KR); Kyung-geun Lee, Gyeonggi-do (KR); In-sik Park, Gyeonggi-do (KR); Chong-sam Chung, Gyeonggi-do (KR); Du-seop Yoon, Gyeonggi-do (KR); Byung-in Ma, Gyeonggi-do (KR); Hyun-soo Park, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (JP)

(21) Appl. No.: 10/652,859

(22) Filed: Sep. 2, 2003

(30) Foreign Application Priority Data
Sep. 2, 2002 (KR) 2002-52606
Sep. 16, 2002 (KR) 2002-56228

(51) Int. Cl. G11B 7/0045; G11B 7/24

(52) U.S. Cl. 369/47.31; 369/275.3

(57) ABSTRACT

An optical information storage medium and a method of recording and/or reproducing information on and/or from the optical information storage medium includes a lead-in area, a user data area, and a lead-out area in which data is recorded. The data that is not modified on storage media complying with the same physical format is recorded in the entire lead-in area or a portion of the lead-in area. A data recording modulation method used in the entire lead-in area or the portion of the lead-in area is different from a data recording modulation method used in a remaining area of the optical information storage medium.

### CROSS-REFERENCE TO RELATED APPLICATIONS

This application claims the priority of Korean Patent Application Nos. 2002-52606 and 2002-56228, filed September 2 and 16, 2002, respectively, in the Korean Intellectual Property Office, the disclosure of which is incorporated herein in their entirety by reference.

### BACKGROUND OF THE INVENTION

1. Field of the Invention

The present invention relates to an optical information storage medium and a method of recording information on and/or reproducing information from the optical information storage medium, and more particularly, to an optical information storage medium having data recorded as pits everywhere thereon, and a first recording modulation method used in a portion of a lead-in area and a second recording modulation method used in a remaining area of the optical information storage medium are different, and a method of recording information on and/or reproducing information from the optical information storage medium.

2. Description of the Related Art

Optical discs are generally used as information storage media of optical pickup devices which record information on and/or reproduce information from the optical discs in a non-contact manner. The optical discs are classified as either compact discs (CDs) or digital versatile discs (DVDs) according to their information recording capacity. The CDs and DVDs further include 650 MB CD-Rs, CD-RWs, 4.7 GB DVD+RWs, DVD-random access memories (DVD-RAMs), DVD-R/rewritables (DVD-RWs), and so forth. Read-only discs include 650 MB CDs, 4.7 GB DVD-ROMs, and the like. Furthermore, high density digital versatile discs (HD-DVD) having a recording capacity of 20 GB or more have been developed.

However, the above-mentioned optical information media are standardized according to their types so as to be compatibly used in reproducing devices. Thus, users can conveniently use the optical information media, and a cost for purchasing the optical information media can be reduced. Attempts to standardize new storage media that are not standardized have been made. In particular, formats of the new storage media have to be developed so that the new storage media are compatible with or consistent with existing storage media. However, the existing storage media use a method of recording data as pits or groove wobbles. Here, the pits are scratches that are physically formed in a substrate when a disc is manufactured, and the groove wobbles are grooves that are formed in a waveform. Also, a pit signal is detected as a jitter value while a groove wobble signal is detected as a push-pull signal.

FIG. 1 is a graph of a push-pull signal and jitter versus a depth of a groove wobble or a pit. The depth of the groove wobble at which an output push-pull signal is highest is about ⅛ (λ/n). Here. λ represents the wavelength of light emitted from a light source used in optical pickup devices and n represents a refractive index of the optical information medium. A maximum depth of the pit at which jitter occurs is ¼ (λ/n). In an optical information storage medium having both the groove wobbles and the pits, it is possible that the depth of the groove wobbles is different from the depth of the pits in consideration of characteristics of the push-pull signal and jitter. However, in a case where the depth of the groove wobbles is different from the depth of the pits, separate processes of forming the groove wobbles and the pits are required. Thus, a process of manufacturing the optical information storage medium becomes complicated. As a result, it is difficult to mass-produce the optical information storage media. Also, if the depth of the groove wobbles is identical to the depth of the pits to simplify the process of manufacturing the optical information storage medium, the characteristics of one or both of the push-pull signal and jitter worsen and recording/reproducing data becomes less efficient.

### SUMMARY OF THE INVENTION

The present invention provides an optical information storage medium which can be manufactured by a simple process, produce good signal characteristics, and be consistent with different types of optical storage media.

Additional aspects and advantages of the invention will be set forth in part in the description which follows and, in part, will be obvious from the description, or may be learned by practice of the invention.

According to an aspect of the present invention, an optical information storage medium includes a lead-in area, a user data area, and a lead-out area in which data is recorded. Data that is not modified depending on storage media to comply with the same physical format is recorded in an entire lead-in area or a portion of the lead-in area, and a first data recording modulation method used in the entire lead-in area or the portion of the lead-in area is different from a second data recording modulation method used in a remaining area of the optical information storage medium.

The entire lead-in area or the portion of the lead-in area in which the data that is not modified depending on the storage media to comply with the same physical format is recorded, may be an area in which optical information storage medium-related information is recorded.

It is possible that the first recording modulation method used for the data that is not modified on the storage media to comply with the same physical format is a bi-phase modulation method, and the second recording modulation method used for remaining data is an RLL modulation method.

It is possible that the RLL modulation method is an RLL (1, 7) modulation method.

A sync pattern used in the RLL (1, 7) modulation method includes at least one of a pit and a space having a length of 9T or more.

The data recorded according to the bi-phase modulation method includes marks of lengths of nT and 2nT and spaces of lengths nT and 2nT, wherein n is within a range of 2≦n≦4.

It is possible that the optical information storage medium further includes an identification mark recorded with a pattern in which the pit and the space having the length of 9T or more repeat at least one time or more.

The sync pattern used in the RLL modulation method may include at least one of a pit and a space having a length of 12T or more.

The data recorded according to the bi-phase modulation method may include marks of the lengths nT and 2nT and spaces of the lengths nT and 2nT. Here, n is within a range of 3≦n≦5.

It is possible that the sync pattern used in the bi-phase modulation method includes at least one of the pit and the space having the length of 12T or more.

According to another aspect of the present invention, a method of recording information on and/or reproducing information from an optical information storage medium having a lead-in area, a user data area, and a lead-out area includes recording data as pits in the lead-in area, the user data area, and the lead-out area. The data that is not modified depending on storage media to comply with the same physical format is recorded in the entire lead-in area or a portion of the lead-in area, and the data is recorded in a remaining area of the optical information storage medium according to a first data recording modulation method that is different from a second data recording modulation method used for the data that is not modified depending on the storage media to comply with the same physical format.

According to another aspect of the present invention, a method of recording and/or reproducing information on and/or from an optical information storage medium having a lead-in area, a user data area, and a lead-out area includes reproducing first data that is not modified depending on storage media to comply with the same physical format, from the entire lead-in area or a portion of the lead-in area using a PLL circuit, and reproducing second data from a remaining area of the optical information storage medium other than the entire lead-in area or the portion of the lead-in area using the PLL circuit.

According to another aspect of the present invention, a drive recording and/or reproducing information on and/or from an optical information storage medium having a lead-in area, a user data area, and a lead-out area includes a recording unit recording first data that is not modified depending on storage media to comply with the same physical format in the entire lead-in area or a portion of the lead-in area according to a first data recording modulation method, and recording second data in a remaining area of the optical information storage medium other than the entire lead-in area or the portion of the lead-in area according to a second data recording modulation method that is different from the first data recording modulation method.

According to another aspect of the present invention, a drive recording and/or reproducing information on and/or from an optical information storage medium having a lead-in area, a user data area, and a lead-out area includes a reader reproducing first data that is not modified depending on storage media to comply with the same physical format, from the entire lead-in area or a portion of the lead-in area using a PLL circuit, and reproducing second data from a remaining area of the optical information storage medium other than the entire lead-in area or the portion of the lead-in area using the PLL circuit.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a graph illustrating variations in a push-pull signal and jitter based on a depth of groove wobbles or a depth of pits in a conventional storage medium;

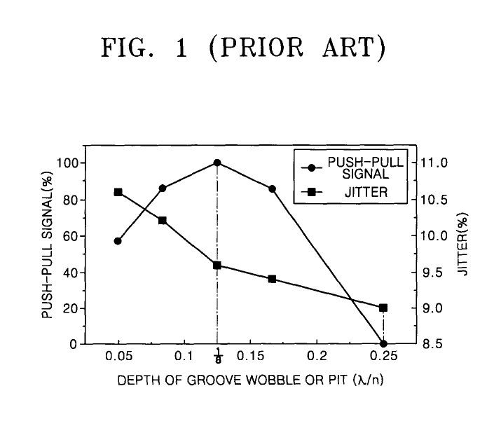

FIG. 2 is a schematic view illustrating a physical structure of a recordable high density optical information storage medium;

FIG. 3 is a view describing a recording modulation method of a groove wobble;

FIG. 4 is a schematic view of a physical structure of an optical information storage medium according to an embodiment of the present invention;

FIG. 5 is a schematic view of a data structure of the optical information storage medium shown in FIG. 4;

FIGS. 6A and 6B are views illustrating various examples of a recording pattern of the optical information storage medium shown in FIG. 4;

FIGS. 7A and 7B are views illustrating examples of an address mark recorded in the recording pattern of the optical information storage medium shown in FIG. 4; and

FIG. 8 is a block diagram showing a drive reproducing information from the optical information storage medium shown in FIG. 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described in order to explain the present invention by referring to the figures.

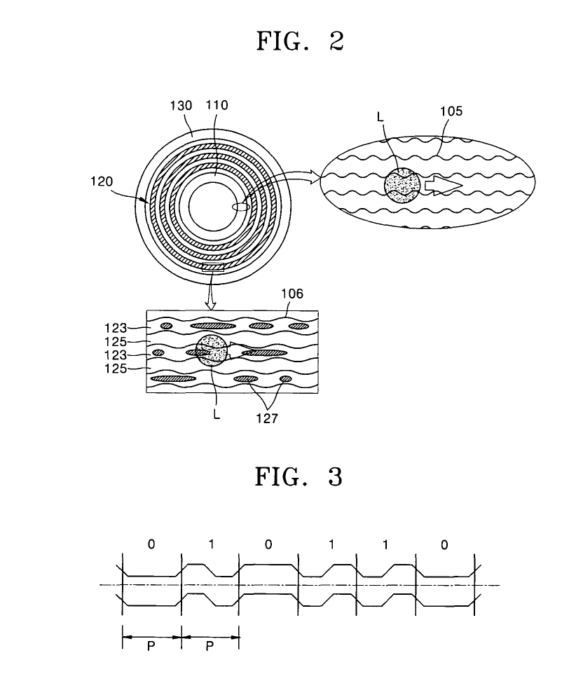

FIG. 2 is a schematic view illustrating a physical structure of a recordable high density optical information storage medium. The recordable high density optical information storage medium includes a lead-in area 110, a user data area 120, and a lead-out area 130, and has groove tracks 123 and land tracks 125. Here, user data may be recorded in the groove tracks 123 only or in both the groove tracks 123 and the land tracks 125.

When read only data is recorded in the lead-in area 110, wobble signals 105 and 106 having a specific frequency and waveform are sequentially recorded at the sidewalls of the groove tracks 123 and/or the land tracks 125, instead of pits. Here, a laser beam L is radiated onto the groove track 123 and/or the land track 125 to record the data on or reproduce the data from the groove track 123 and/or the land track 125. In particular, each of the lead-in area 110 and the lead-out area 130 includes a recordable area in which disc-related data is recorded, and a read only area. The disc-related data is recorded in a form of a high frequency wobble 105, and data in the recordable areas of the lead-in area 110 and the lead-out area 130 and the data in the user data area 120 are recorded in a form of another frequency wobble 106 relatively lower than the high frequency wobble 105. Reference numeral 127 denotes recording marks formed in the user data area 120.

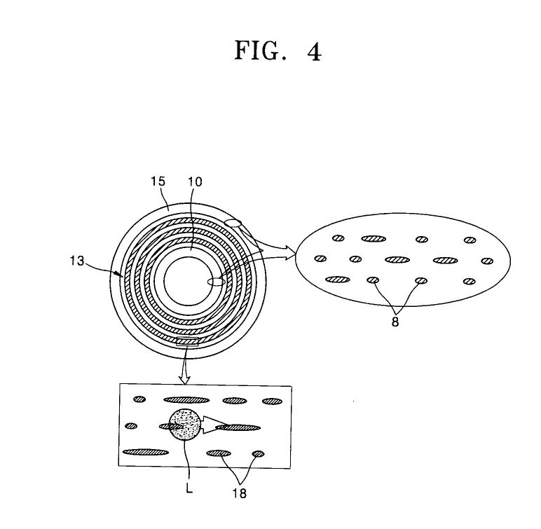

In the optical information storage medium having the above-described structure, the read only data may be reproduced from the lead-in area 110 using a push-pull channel, and the user data may be reproduced from the user data area 120 using a sum channel. Also, the data is recorded in the lead-in area 110 according to a bi-phase modulation method, and the user data is recorded according to a Run-Length-Limited (RLL) modulation method that will be explained later. The bi-phase modulation method refers to a method of recording the data depending on whether a signal varies within a predetermined period P. For example, as shown in FIG. 3, when a phase of the groove wobble 105 or 106 is not changed within a predetermined period P, data of 0 (or 1) bit is displayed. When the phase of the groove wobble 105 or 106 is shifted or changed within the predetermined period P, data of 1 (or 0) bit is displayed. In other words, the bi-phase modulation method is a method of recording the data depending on whether a predetermined signal varies within the predetermined period P, e.g., depending on whether the phase of a signal is changed within the predetermined period P. Here, modulation of the phase of the groove wobble 105 or 106 has been described, but various patterns may be modulated.

Considering consistency of a data recording modulation method of the above-described recordable high-density optical information storage medium with another data recording modulation method of a read-only optical information storage medium according to the present invention, the physical data structure of the read-only optical information storage medium may be constituted as follows.

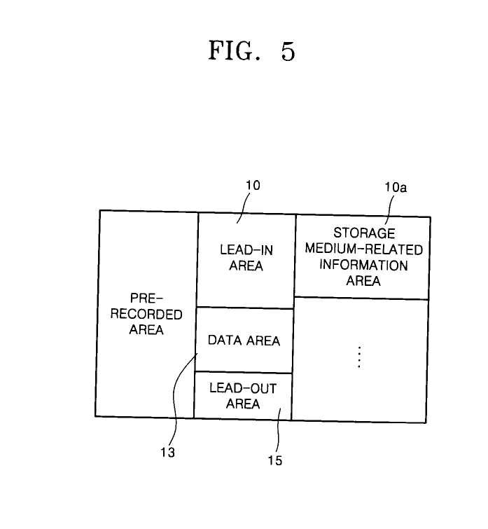

Referring to FIG. 4, the optical information storage medium according to an embodiment of the present invention includes a user data area 13 in which user data is recorded, a lead-in area 10 which is formed inside the user data area 13, and a lead-out area 15 which is formed outside the user data area 13. In the lead-in area 10, the user data area 13, and the lead-out area 15, data is recorded as pits 8 and 18. The pits 8 and 18 are formed in a substrate when the optical information storage medium is manufactured. If the data is recorded as the pits 8 and 18 everywhere on the optical information storage medium, the pits 8 and 18 can be formed in the lead-in area 10 and the user data area 13 without stopping (changing) a process of forming the pits 8 and 18. Thus, the process of manufacturing the optical information storage medium can be simplified, and time required for performing the process can be reduced. Also, since the optical information storage medium does not have a groove wobble shown in FIG. 2, the pits 8 and 18 can be formed to an optimal depth. In other words, as described with reference to FIG. 4, the pits 8 and 18 may be formed to a depth, e.g., a depth of ¼ (n/λ), at which jitter is at best (maximum).

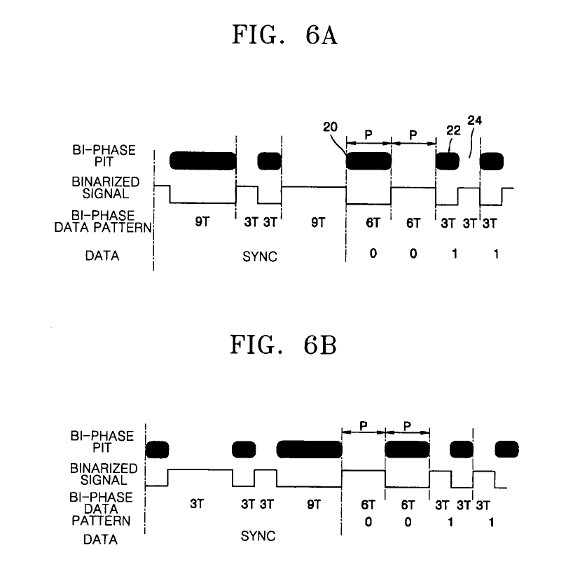

In particular, as shown in FIG. 5, in all or a portion 10a of the lead-in area 10, information that is not modified on the storage media complying with the same physical format (a modulation method, a minimum pit length, a track pitch, and the like), e.g., storage medium-related information, is recorded. For example, the information that varies depending on contents of the optical information storage medium, e.g., information about a last address of a portion of the user data area 13 in which the data is recorded, may be recorded in a remaining area of the optical information storage medium, i.e., in the remaining portion of the lead-in area 10 or the lead-out area 15.

While the data is recorded as the pits 8 and 18 everywhere on the optical information storage medium, a first data recording modulation method used in the all or the portion 10a of the lead-in area 10 is different from a second data recording modulation method used in the remaining area of the optical information storage medium. For example, the bi-phase modulation method may be used in throughout the entire lead-in area 10, or just in the portion 10a of the lead-in area 10 while the RLL modulation method is used in the remaining area of the optical information storage medium. Hereinafter, the portion 10a is referred to as a storage medium-related information area.

In the optical information storage medium and the method of recording information on and/or reproducing information from the optical information storage medium, the data is recorded as the pits 8 or 18 everywhere on the optical information storage medium, and the data is recorded in throughout the entire lead-in area 10 or just in the storage medium-related information area 10a of the lead-in area 10 according to the bi-phase modulation method and in the remaining area of the optical information storage medium according to the RLL modulation method.

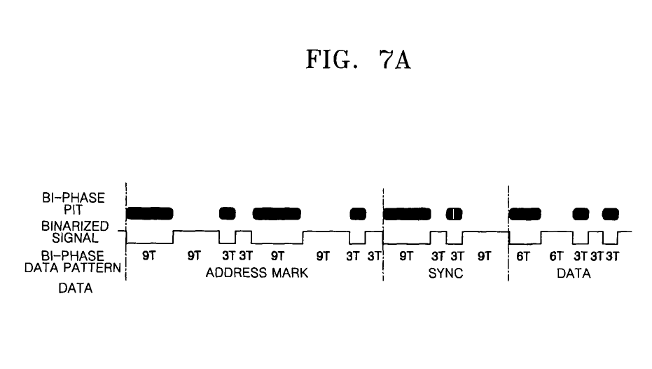

As shown in FIG. 6A, in the bi-phase modulation method, if the phase of a pit is not changed within a predetermined period P, data of bits of value “0” (or “1”) is recorded, and if the phase of the pit is changed within the predetermine period P, data of bits of value “1” (or “0”) is recorded. In other words, if a pit 20 is formed everywhere within the predetermined period P, the data of bits of value “0” (or “1”) is recorded, and if a pit 22 and a space 24 are formed within the predetermined period P, the data of bits of value “1” (or “0”) is recorded. Bi-phase-modulated pits, a binarized signal, a pattern of bi-phase-modulated data, and a data structure are shown in FIG. 6A.

The RLL modulation method indicates how many bits of value “0” exist between two bits of value “1”. Here, RLL (d, k) represents that a minimum number and a maximum number of bits of value “0” between two bits of value “1” are d and k, respectively. For example, in an RLL (1, 7) modulation method, the minimum number and the maximum number of bits of value “0” between two bits of value “1” are 1 and 7, respectively. According to the RLL (1, 7) modulation method, when d=1, data of 1010101 is recorded and thus a mark of length 2T is formed between two bits of value “1”. Also, when d=7, data of 10000000100000001 is recorded and thus a mark of length 8T is formed between two bits of value “1”. Here, T denotes a minimum mark length, i.e., a minimum pit length. Thus, in the RLL (1, 7) modulation method, the data is recorded as a mark and a space having lengths of 2T and 8T. Here, the data recorded according to the bi-phase modulation method includes pits of lengths nT and 2nT and spaces of lengths nT and 2nT. It is possible that n is within a range of 2≦n≦4. For example, if n=2, the data recorded according to the bi-phase modulation method includes pits of lengths 2T and 4T and spaces of lengths 2T and 4T. If n=4, the data recorded according to the bi-phase modulation method includes pits of lengths 4T and 8T and spaces of lengths 4T and 8T. Thus, when n is within the range of 2≦n≦4, all data composed of pits of lengths nT and 2nT and spaces of lengths nT and 2nT are included within the range of lengths of the mark and the space formed according to the RLL (1, 7) modulation method.

During reproducing of the data from the pits and the spaces according to the bi-phase modulation method, when the phase of the pit and the space is changed within a period of 2nT, the pit and the space can be read as data of bits of value “1” (or “0”) bit. When the phase of the pit and the space is not changed within the period of 2nT, the pit and the space can be read as data of bits of value “0” (or “1”).

A sync pattern can be recorded before each of an area in which the bi-phase modulation method is used, and an area in which the RLL modulation method is used. It is possible that the sync pattern includes at least one of the pit and the space having a length that is not included within a range of a maximum pit or space length.

For example, if the RLL (1, 7) modulation method is used in the user data area 13, the sync pattern can include at least one of the pit and the mark having a length of 9T or more, and the pit and the space having a length of 9T or less. In the RLL (1, 7) modulation method, it is possible that the pit and the space have a length within a range of 3T-8T, and the sync pattern includes at least one of the pit and the space having a length that is not included within a range of 3T-8T. For example, it is possible that the sync pattern includes at least one of the pit and the mark having the length of 9T, and the pit and the space having the length of 9T or less.

Also, it is possible that the sync pattern used in the bi-phase modulation method includes the pit or space of the maximum length contained in the sync pattern used in the RLL modulation method.

As described above, a period of the pit and the space recorded according to the bi-phase modulation method can be included within a range of a period of the pit and the space used in the RLL modulation method, and the sync pattern used in the bi-phase modulation method can include the pit or space of the maximum length contained in the sync pattern used in the RLL modulation method. As a result, read-only data pits recorded in the storage medium-related information area 10a of the lead-in area 10 and data pits recorded in the user data area 13 can be reproduced using the same phase-locked loop (PLL) circuit.

Describing an example of data constituted according to the above-descried method, the sync pattern can include at least one of the pit of a length 9T and the mark of the length 9T, and the pit and the space having the length of 9T or less. Also, if the user data is recorded as pits of lengths 3T and 6T and spaces of lengths 3T and 6T, a length of 6T is determined as a standard period. Next, if the phase of a signal is not changed within the period of 6T, data of bits of value “0” (or “1”) can be regarded as being recorded, and if the phase of the signal is changed within the period of 6T, data of bits of value “1” (or “0”) can be regarded as being recorded. For example, when a pit of length 3T and a space of length 3T are included within the period of 6T, the phase of the signal is changed. Here, the standard period may be changed from 6T to 4T or 8T depending on reliability or characteristics of reproduced data. In this case, the data is recorded as the pits of lengths 2T and 4T and the spaces of lengths 2T and 4T, and the pits of lengths 4T and 8T and the spaces of lengths 4T and 8T instead of the pits of lengths 3T and 6T and the spaces of lengths 3T and 6T. However, when the sync pattern includes the pit or mark of the length 9T, and the data is recorded as the pits of lengths 3T and 6T and the spaces of lengths 3T and 6T within the standard period of 6T, a reproduction error rate of the data can be reduced. When the data is reproduced as the pits of lengths 2T and 4T and the spaces of lengths 2T and 4T, the pits of lengths 2T and 4T and the spaces of the lengths 2T and 4T can be corrected as the pits of the length 3T and the spaces of the length 3T adjacent thereto to reduce the reproduction error rate. Also, when the data is reproduced as pits of lengths 5T and 7T and spaces of lengths 5T and 7T, the pits of lengths 5T and 7T and the spaces of the lengths 5T and 7T can be corrected as the pits of length 6T and spaces of 6T adjacent thereto to reduce the reproduction error rate. Moreover, when the data is reproduced as pits of lengths 8T and 10T and spaces of the lengths 8T and 10T, the pits of the lengths 8T and 10T and the spaces of the lengths 8T and 10T can be corrected as pits of length 9T and spaces of 9T thereto to reduce the reproduction error rate. Although not shown, as previously described, the sync pattern can also be recorded in the user data area 13.

FIG. 6B illustrates an example of a data structure that is bi-phase-modulated. Here, the data structure shown in FIG. 6B has an opposite polarity to the data structure shown in FIG. 6A.

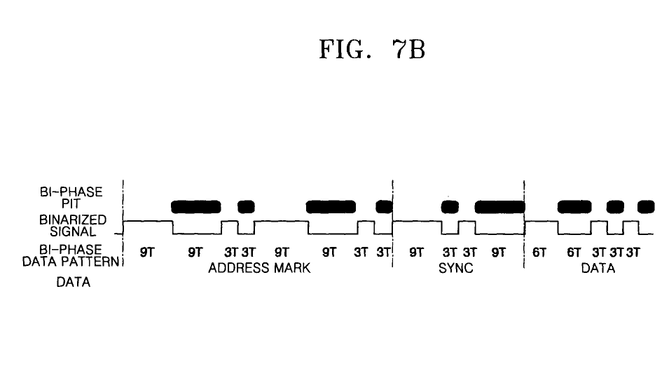

As shown in FIG. 7A, an identification mark can be recorded before and after the storage medium-related information area 10a so that the storage medium-related information area 10a storing information according to the bi-phase modulation method is identified to be different from the user data area 13. The identification mark can be constituted so that the pit and/or the space having the same length as the pit or space of the maximum length contained in the sync pattern used in the RLL (1, 7) modulation method and the bi-phase modulation method are repeated at least one time or more.

FIG. 7B illustrates a data structure having an opposite polarity to the data structure shown in FIG. 7A.

The optical information storage medium and the method of recording the information on and/or reproducing the information from the optical information storage medium shown in FIGS. 7A and 7B will be described.

According to the present embodiment, the data is recorded as the pits everywhere in the lead-in area 10, the user data area 13, and the lead-out area 15. Here, the data is recorded in the lead-in area 10 or the storage medium-related information area 10a of the lead-in area 10 according to the bi-phase modulation method and in the remaining area of the optical information storage medium according to the RLL (2, 10) modulation method. The storage medium-related information area 10a is an area in which the information that is not modified on the storage media to comply with the same physical format is recorded, and the remaining area denotes the remaining portion of the lead-in area 10, the user data area 13, and/or the lead-out area 15. Fore example, the information that is not modified on the storage media to comply with the same physical format is storage medium-related information.

According to the RLL (2, 10) modulation method, data is recorded as the marks, i.e., the pits, and the spaces having a length within a range of 3T-11T. Here, the data recorded according to the bi-phase modulation method includes the pits of lengths nT and 2nT and the spaces of the lengths nT and 2nT. It is possible that n is within a range of 3≦n≦5. For example, if n=3, the data recorded according to the bi-phase modulation method includes the pits of the lengths 3T and 6T and the spaces of the lengths 3T and 6T. If n=5, the data recorded according to the bi-phase modulation method includes the pits of the lengths 5T and 10T and the spaces of the lengths 5T and 10T. Thus, the length of the pits and the spaces formed according to the bi-phase modulation method is included within a range of length (3T-11T) of the user data recorded according to the RLL (1, 7) modulation method. As a result, as previously described, the data pits recorded in the user data area 13 and the data pits recorded in the lead-in area 10 can be reproduced using the same PLL circuit.

Meanwhile, the sync pattern can be recorded ahead of each of an area using the bi-phase modulation method and an area using the RLL (2, 10) modulation method. It is possible that the sync pattern includes at least one of a pit and a space having a length of 1 2T or more, and a pit and a space having the length of 12T or less. For example, the sync pattern can be constituted so that a sequence of the pit and the space having the length of 12T is repeated at least one time, and the user data is recorded with 2nT, i.e., one of 6T, 8T, and 10T, determined as the standard period.

For example, when length 8T is determined as the standard period, if the phase of the signal is not shifted (changed) within the standard period of 8T, data of bits of value “0” (or “1”) is displayed, and if the phase of the signal is shifted (changed) within the standard period of 8T, data of bits of value “1” (or “0”) is displayed. Here, when the phase of the signal is not shifted (changed) within the standard period of 8T, the pit or the space is formed everywhere within the standard period of 8T. In contrast, when the phase of the signal is shifted (changed) within the standard period of 8T, the pit of the length 4T and the space of the length 4T are formed within the standard period of 8T.

In addition, it is possible that an identification mark is recorded in front of and behind an area using the bi-phase modulation method so that the area is differentiated from another area in which the user data is recorded according to the RLL (2, 10) modulation method. Here, the identification mark can be constituted so that the pit and/or the space having the length of 12T or more is repeated at least one time or more, and the pit and the space having the length of 12T or less are recorded.

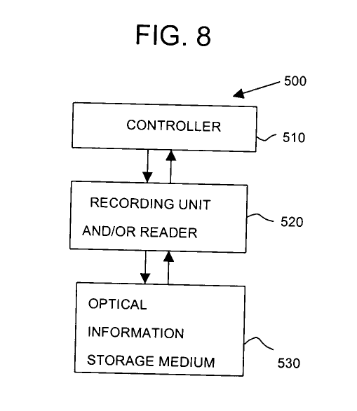

FIG. 8 is a block diagram showing a drive 500 reproducing information from the optical information storage medium shown in FIG. 4. Referring to FIG. 8, the drive 500 includes a controller 510 and a recording unit and/or reader 520 recording and/or reproducing the data on and/or from the optical information storage medium, such as an optical disk 530.

The optical information storage medium according to the present invention may be applied to a storage medium having one or more information surfaces.

As described above, according to the optical information storage medium and the method of recording the data on and/or reproducing the data from the optical information storage medium, the pits are formed throughout the entire optical information storage medium. Thus, a process of manufacturing the optical information storage medium can be simplified. Also, the pits can be formed to a depth at which an optimum signal is output. Thus, recording/reproducing characteristics can be improved. In other words, since the pits are reproduced through the same reproduction channel (sum channel), differences in characteristics of the signal due to the groove or the pit do not have to be considered.

Also, the data recording modulation method used in the lead-in area or the portion of the lead-in area and the data recording modulation method used in the user data area can be equal to the another recording modulation method used on the recordable optical information storage medium. Thus, the recordable optical information storage medium can be consistent with other storage media. Moreover, a large amount of data can be recorded compared with when the data is recorded as the groove wobble, and read-only data recorded in the lead-in area and user data can be reproduced using the same PLL circuit. Furthermore, since the identification mark can be recorded so that a drive can efficiently access a specific area, an access time of the drive can be reduced.

Although a few embodiments of the present invention have been shown and described, it would be appreciated by those skilled in the art that changes may be made in this embodiment without departing from the principles and sprit of the invention, the scope of which is defined in the claims and their equivalents.

What is claimed is:

1. An optical information storage medium encoded with data readable by one of a computer and a drive to implement a method of recording data in a lead-in area, a user data area, and a lead-out area, comprising:
first data that is used for reproducing a first signal, and that is not modified depending on storage media to comply with the same physical format and is recorded in the entire lead-in area or a portion of the lead-in area using a first data recording modulation method; and
second data that is used for reproducing a first signal, and that is recorded in a remaining area of the optical information storage medium other than the entire lead-in area or the portion of the lead-in area using a second data recording modulation method different from the first data recording modulation method.

2. The optical information storage medium of claim 1, wherein the entire lead-in area or the portion of the lead-in area is an area in which optical information storage medium-related information is recorded.

3. The optical information storage medium of claim 2, wherein the first data recording modulation is a bi-phase modulation method, and the second data recording modulation method is an RLL modulation method.

4. The optical information storage medium of claim 3, wherein the RLL modulation method is an RLL (1, 7) modulation method.

5. The optical information storage medium of claim 4, further comprising:
a sync pattern which is formed in the remaining area of the optical information storage medium other than the entire lead-in area or the portion of the lead-in area using the RLL (1, 7) modulation method and comprises at least one of a pit and a space having a length of 9T or more.

6. The optical information storage medium of claim 3, wherein the first data recorded according to the bi-phase modulation method comprises marks of lengths of nT and 2nT and spaces of lengths nT and 2nT where n is within the range of 2≦n≦4.

7. The optical information storage medium of claim 6, further comprising:
a sync pattern which is formed in the entire lead-in area or the portion of the lead-in area using the bi-phase modulation method and comprises at least one of a pit and a space having a length of 9T or more.

8. The optical information storage medium of claim 7, further comprising:
an identification mark recorded with a pattern in which a pit and a space having the length of 9T or more is repeated at least one time or more.

9. The optical information storage medium of claim 3, wherein the RLL modulation method is an RLL (2, 10) modulation method.

10. The optical information storage medium of claim 9, further comprising:
a sync pattern which is formed in the remaining area of the optical information storage medium other than the entire lead-in area or the portion of the lead-in area using the RLL modulation method and comprises at least one of a pit and a space having a length of 12T or more.

11. The optical information storage medium of claim 10, wherein the first data recorded according to the bi-phase modulation method comprises:
marks of lengths nT and 2nT and spaces of lengths nT and 2nT where n is within the range of 3≦n≦5.

12. The optical information storage medium of claim 11, further comprising:
a sync pattern which is formed in the remaining area of the optical information storage medium other than the entire lead-in area or the portion of the lead-in area using the bi-phase modulation method and comprises at least one of a pit and a space having a length of 12T or more.

13. The optical information storage medium of claim 12, further comprising:
an identification mark recorded with a pattern in which a pit and a space having a length of 12T or more are repeated at least one time or more.

14. The optical information storage medium of claim 11, further comprising:
an identification mark recorded with a pattern in which a pit and a space having a length of 12T or more are repeated at least one time or more.

15. The optical information storage medium of claim 1, wherein the first data recording modulation method is a bi-phase modulation method, and the second data recording modulation method is an RLL modulation method.

16. The optical information storage medium of claim 15, wherein the RLL modulation method is an RLL (1, 7) modulation method.

17. The optical information storage medium of claim 16, further comprising:
a sync pattern which is formed in the remaining area of the optical information storage medium other than the entire lead-in area or the portion of the lead-in area using the RLL (1, 7) modulation method and comprises at least one of a pit and a space having a length of 9T or more.

18. The optical information storage medium of claim 15, wherein the first data recorded according to the bi-phase modulation method comprises:
marks of lengths of nT and 2nT and spaces of the lengths nT and 2nT where n is within a range of 2≦n≦4.

19. The optical information storage medium of claim 18, further comprising:
a sync pattern which is formed in the entire lead-in area or the portion of the lead-in area using the bi-phase modulation method and comprises at least one of a pit and a space having a length of 9T or more.

20. The optical information storage medium of claim 19, further comprising:
an identification mark recorded with a pattern in which a pit and a space having a length of 9T or more is repeated at least one time or more.

21. The optical information storage medium of claim 15, wherein the RLL modulation method is an RLL (2, 10) modulation method.

22. The optical information storage medium of claim 21, further comprising:
a sync pattern which is formed in the remaining area of the optical information storage medium other than the entire lead-in area or the portion of the lead-in area using the RLL modulation method and comprises at least one of a pit and a space having a length of 12T or more.

23. The optical information storage medium of claim 3, wherein a length of a pit or space used in the bi-phase modulation method is included within a range of a length of a pit or space used in the RLL modulation method.

24. The optical information storage medium of claim 1, further comprising:
one or more information surfaces formed with the first and second data.

25. A method of recording information on and/or reproducing information from an optical information storage medium having a lead-in area, a user data area, and a lead-out area, the method comprising:
recording first data that is not modified depending on storage media to comply with the same physical format, in the entire lead-in area or a portion of the lead-in area according to a first data recording modulation method; and
recording second data in a remaining area of the optical information storage medium other than the entire lead-in area or the portion of the lead-in area according to a second data recording modulation method that is different from the first data recording modulation method.

26. The method of claim 25, wherein the recording of the first data in the entire lead-in area or the portion of the lead-in area comprises:
recording the first data in an area in which optical information storage medium-related information is recorded.

27. The method of claim 26, wherein the first data recording modulation method is a bi-phase modulation method, and the second data recording modulation method is an RLL modulation method.

28. The method of claim 27, wherein the RLL modulation method is an RLL (1, 7) modulation method.

29. The method of claim 28, further comprising:
forming a sync pattern which is formed in the remaining area using the RLL (1, 7) modulation method and comprises at least one of a pit and a space having a length of 9T or more.

30. The method of claim 29, wherein the first data recorded according to the bi-phase modulation method comprises:
marks of lengths of nT and 2nT and spaces of lengths nT and 2nT where n is within the range of 2≦n≦4.

31. The method of claim 29, further comprising:
forming a sync pattern which is formed in the entire lead-in area or the portion of the lead-in area using the bi-phase modulation method and comprises at least one of a pit and a space having a length of 9T or more.

32. The method of claim 27, further comprising:
forming an identification mark recorded with a pattern in which a pit and a space having a length of 9T or more is repeated at least one time or more.

33. The method of claim 32, wherein the RLL modulation method is an RLL (2, 10) modulation method.

34. The method of claim 33, further comprising:
forming a sync pattern in the remaining area using the RLL modulation method and having at least one of a pit and a space having a length of 12T or more.

35. The method of claim 34, wherein the first data recorded according to the bi-phase modulation method comprises:
marks of lengths nT and 2nT and spaces of lengths nT and 2nT where n is within a range of 3≦n≦5.

36. The method of claim 33, further comprising:
forming a sync pattern in the entire lead-in area or the portion of the lead-in area using the bi-phase modulation method and recorded with a pattern in which a sequence of a mark and a space having a length of 12T or more is repeated at least one time or more.

37. The method of claim 27, wherein further comprising:
forming an identification mark recorded with a pattern in which a pit and a space having a length of 12T or more are repeated at least one time or more, in the entire lead-in area or the portion of the lead-in area.

38. The method of claim 27, wherein a length of a pit or space used in the bi-phase modulation method is included within a range of a length of a pit or space used in the RLL modulation method.

39. The method of claim 25, wherein the first data recording modulation method is a bi-phase modulation method, and the second data recording modulation method is an RLL modulation method.

40. The method of claim 39, wherein the RLL modulation method is an RLL (1, 7) modulation method.

41. The method of claim 40, further comprising:
forming a sync pattern using the RLL (1, 7) modulation method in the remaining area and having at least one of a pit and a space having a length of 9T or more.

42. The method of claim 41, wherein the first data recorded according to the bi-phase modulation method comprises:
marks of lengths of nT and 2nT and spaces of lengths nT and 2nT where n is within a range of 2≦n≦4.

43. The method of claim 41, further comprising:
forming a sync pattern in the entire lead-in area or the portion of the lead-in area using the bi-phase modulation method and having at least one of a pit and a space having a length of 9T or more.

44. A method of recording information on and/or reproducing information from an optical information storage medium having a lead-in area, a user data area, and a lead-out area, the method comprising:
recording first data in the entire lead-in area or a portion of the lead-in area according to a first data recording modulation method; and
recording second data in a remaining area of the optical information storage medium other than the entire lead-in area or the portion of the lead-in area according to a second data recording modulation method that is different from the first data recording modulation method.

45. The method of claim 44, wherein the first data is not changed depending storage media to comply with the same physical format.

46. The method of claim 44, wherein the first data recording modulation method is a bi-phase modulation method, and the second data recording modulation method is an RLL modulation method.

47. The method of claim 46, wherein recording of the first data and the recording of the second data comprise recording a pit and a space in the on the lead-in area, a user data area, and a lead-out area, and a period of the pit and the space recorded according to the bi-phase modulation method is included within a range of a period of the pit and the space used in the RLL modulation method.

48. The method of claim 46, wherein recording of the first data and the recording of the second data comprise recording a sync pattern using the bi-phase modulation method, and the sync pattern includes the pit or space of a maximum length contained in the sync pattern recorded using the RLL modulation method.

49. The method of claim 46, wherein the first data and second data are reproducible using the same phase-locked loop (PLL) circuit.

50. A method of recording and/or reproducing information on and/or from an optical information storage medium having a lead-in area, a user data area, and a lead-out area, the method comprising:
reproducing first data from the entire lead-in area or a portion of the lead-in area using a PLL circuit; and
reproducing second data from a remaining area of the optical information storage medium other than the entire lead-in area or the portion of the lead-in area using the PLL circuit.

51. A drive recording and/or reproducing information on and/or from an optical information storage medium having a lead-in area, a user data area, and a lead-out area, the drive comprising:
a recording unit recording first data in the entire lead-in area or a portion of the lead-in area according to a first data recording modulation method, and recording second data in a remaining area of the optical information storage medium other than the entire lead-in area or the portion of the lead-in area according to a second data recording modulation method that is different from the first data recording modulation method.

52. A drive recording and/or reproducing information on and/or from an optical information storage medium having a lead-in area, a user data area, and a lead-out area, the drive comprising:
a reader reproducing first data that is not modified depending on storage media to comply with the same physical format, from the entire lead-in area or a portion of the lead-in area using a PLL circuit, and reproducing second data from a remaining area of the optical information storage medium other than the entire lead-in area or the portion of the lead-in area using the PLL circuit.
